(19) United States
(12) Patent Application Publication
(10) Pub. No.: US 2013/0124307 A1
(43) Pub. Date: May 16, 2013

(54) DEVICE AND METHOD FOR AUTOMATICALLY DISTRIBUTING PROMOTIONAL ITEMS

(71) Applicant: Sang Jin Han, Seoul (KR)

(72) Inventor: Sang Jin Han, Seoul (KR)

(21) Appl. No.: 13/810,414

(22) PCT Filed: Nov. 16, 2010
(86) PCT No.: PCT/KR2010/008089

§ 371 Date: Jan. 15, 2013

(30) Foreign Application Priority Data
Jul. 29, 2010 (KR) 10-2010-0073540

(51) Int. Cl. G06Q 30/02

(52) U.S. Cl. CPC G06Q 30/0257
USPC 705/14.47

(57) ABSTRACT

A device for automatically distributing promotional items stores a plurality of promotional items and distributes the selected promotional items according to a demand by a user. The device includes: display and input units for the display and the manipulation by a user; an access code recognition unit for recognizing an access code provided by the user; a memory for storing reference data to be compared with the recognized access code; a promotional item storing unit and a promotional item output unit for storing and distributing the promotional items to the user; and a controller that compares the reference data and the access code with each other, which determines whether to distribute the promotion item selected by the user or not, and controlling the respective sections according to the determination.

### TECHNICAL FIELD

The present invention relates generally to an automated promotional item dispenser and a method thereof, and specifically to a novel automated promotional item dispenser and a method thereof configured to output a desired promotional item from the automated promotional item dispenser by using an access code received in return for a user providing his/her own personal information.

### BACKGROUND ART

In general, a company or a business office distributes promotional items made by printing or carving the logo of the company, the name of the business office, or a rough map on useful materials widely used by general consumers as a means for advertisement. However, the conventional method of distributing the promotional items includes directly distributing them to customers visiting the business office, delivering them by post when they have customer information, randomly distributing them to people passing by in front of a subway station or on a street with a great floating population, or the like. The distribution methods like this greatly cost labor forces and time, it is difficult to correctly deliver the promotional items to be advertised to a target consumer, and the overlapped delivery to one user is not restricted.

In order to solve the problems, an automated dispenser has been conventionally proposed. For example, Korean Patent Publication No. 10-2004-0057845 discloses an automated dispenser for distributing sample products. This relates to an automated machine for providing a sample product selected by a user when the user inserts his/her identification card, and selecting a desired sample product after his/her identification is identified and the distribution condition such as a sex, an age, and a provision-or-not are checked.

However, this technique has a problem in that there is a high risk of exposing the personal information of the user to a third party. Further, there has been a limitation in that the information for distinguishing a target consumer is nothing but the sex and the age in the resident registration information included in the identification card. The distinction of the target consumer based on such restricted information is not greatly different from distributing the promotional item by directly distinguishing the target consumers by sight.

Meanwhile, if one can acquire personal information such as an address for communication like e-mail information and a cellular phone number, marriage status, housing ownership, car ownership, hobbies, property, or the like, the target consumers may be precisely and finely classified according to the purpose of the advertiser.

Therefore, in the automated promotional item dispenser, there is an earnest demand for a technique for automatically providing promotional items that can minimize the risk of exposing the identification information of the user to the third party, that can spontaneously obtain personal information of the user so that the information can be used for additional marketing, and that can prevent the overlapped provision of unnecessary promotional items.

### DETAILED DESCRIPTION OF THE INVENTION

### Technical Problem

The present invention is conceived for improving and complementing the conventional automated promotional item providing technique described above, and providing various kinds of additional advantages. The present invention is to provide a novel automated promotional item dispenser and a method thereof in which the risk of unnecessarily exposing the identification information of the user to a third party is minimized, and the personal information of the user is spontaneously acquired so that the information can be used for an additional marketing, by configuring the invention so that the user can output desired promotional items from the automated promotional item dispenser by using an access code received in return for providing his/her own personal information.

### Technical Solution

The object of the invention is achieved by an automated promotional item dispenser and a method thereof provided according to the present invention.

An automated promotional item dispenser provided according to an aspect of the present invention stores a plurality of promotional items and provides a promotional item selected by a user from among the stored promotional items according to a request of the user. The automated promotional item dispenser includes: a display means that performs a display to the user and an input means that the user can can operate; an access code recognition unit for recognizing an access code provided by the user; a memory storing reference information that is information compared with the recognized access code; a promotional item storing unit and a promotional item output unit for storing promotional items and providing the promotional items to the user; and a controller that compares the reference information and the access code, determines whether to provide the promotional item selected by the user, and controls each of the units depending on the determination. Here, the access code, which is provided by the user, is provided in advance by the promotional item provider, at least one item of his/her own personal information is provided on the condition that the promotional item will be provided in return, and which includes the provided personal information in a coded manner.

*According to an embodiment, the provision of the access code from the promotional item provider to the user is performed between a user terminal and an operator server system of a promotional item provider that can be connected through a communication network that can perform a bidirectional data communication by a user terminal providing personal information of the user and the operator server system generating the access code and providing the access code to the user terminal through the communication network.

According to another embodiment, the provision of the access code from the promotional item provider to the user is performed by the user providing the personal information of the user by the input means, and the controller generating the access code to display the access code to the user, and then transmit the access code to a portable terminal of the user, or manufacture and output an access card in a form of an electronic card.

According to still another embodiment, the access code includes at least one item of information physically imprinted on an electronic card provided to the user, magnetically readable information, and information readable by a near field communication means.

According to still another embodiment, the access code is provided in a form of a code transmitted to a portable terminal of the user.

According to still another embodiment, the personal information provided for receiving the access code comprises an address for a communication including at least one of an e-mail address and a portable terminal connection number of the user.

According to still another embodiment, the personal information provided for receiving the access code further comprises additional information including at least one of a name, a home address, a residence registration number, a hobby, a job, owned property, and a human relationship of the user.

According to still another embodiment, the personal information provided for receiving the access code further comprises biometric information derived from at least one of an iris, a fingerprint, a face shape, and a voice of the user.

According to still another embodiment, the access code further comprises a limiting condition including at least one of a kind, a quantity, a providable date, and a providable region in a coded manner depending on the kind of the personal information provided by the user.

According to still another embodiment, the automated promotional item dispenser further includes a communication interface that enables wired/wireless data communications respectively, and a plurality of the automated promotional item dispensers are connected to an operator server system of the promotional item provider through the respective communication interfaces so that the user relating to the promotional item provision and the data relating to the promotional item are configured to be mutually updated.

An automated promotional item providing method provided according to another aspect of the invention stores a plurality of promotional items and provides a promotional item selected by a user from among the stored promotional items according to a request of the user. The automated promotional item providing method includes a step of providing, by the promotional item provider, an access code to the user after the user provides his/her own personal information on the condition that the promotional item will be provided in return and including personal information in a coded manner; a step of recognizing an access code provided by the user; a step of comparing the recognized access code with reference information which is stored in advance; a step of determining whether to provide a promotional item selected by the user based on the comparison result; and a step of outputting an error message when it is determined the provision is not permitted, or outputting the determined promotional item when it is determined that the provision is permitted.

According to an embodiment, the step of providing, by the promotional item provider, an access code to the user is performed between a user terminal and an operator server system of a promotional item provider that can be connected through a communication network that can perform a bidirectional data communication by a user terminal providing personal information of the user and the operator server system generating the access code and providing the access code to the user terminal through the communication network.

According to the another embodiment, when it is determined that the provision is not permitted, after outputting an error message, a step of providing an updated access code that enables the user to receive the selected promotional item in return for further providing additional information is further included.

### Advantageous Effects

The present invention with the configuration described above provides an effect of minimizing the risk of exposing the identification information of the user to a third party, and spontaneously acquiring the personal information of the user so that the information of the user can be utilized for an additional marketing.

### BRIEF DESCRIPTION OF THE DRAWINGS

FIG. 1 is a block diagram schematically illustrating a configuration of an automated promotional item dispenser according to an embodiment of the present invention;

FIG. 2 is a diagram schematically illustrating a process in which a user receives an access code to be used in an automated promotional item dispenser according to an embodiment of the present invention;

FIG. 3 is a block diagram schematically illustrating a configuration of an automated promotional item dispenser according to another embodiment of the present invention;

FIG. 4 is a block diagram schematically illustrating a configuration of an automated promotional item dispenser according to still another embodiment of the present invention; and

FIGS. 5 to 7 are flowcharts illustrating processes providing promotional items from an automated promotional item dispenser according to embodiments of the present invention.

### MODE FOR CARRYING OUT THE INVENTION

Hereinafter, the embodiments of the present invention are described in detail with reference to the accompanying drawings as follows.

The present invention relates to an automated technique for automatically dispensing promotional items. In the present invention, the “promotional item” may include any materials without limitation as long as they are effective to a user for public relations, advertisements, or promotions. The materials that can be used as promotional items may be candies, ballpoint pens, tissues, samples, calendars, notebooks, clothes, and the like, and the kind thereof has no limitation. It is general that on the promotional item, a trademark of an advertiser seeking an effect on advertisement or public relations or a text for advertisement or public relations such as a brand of a product, an advertisement text, and/or the like is printed on the material.

However, it is not necessary for the present invention to be limited to being applied only to a promotional item with a confined meaning. As long as the material has an effective value for a user, regardless of whether the advertisement is printed or not, any item can be applied without limitation. The feature of the present invention lies not in acquiring such a material by inserting money or an ID card, but in acquiring it by using an “access code”. That is, the automated promotional item dispenser according to the present invention is an apparatus that stores a plurality of promotional items, and dispenses one which is selected by a user from among the stored promotional items according to a request of the user who presents an “access code”.

The “access code” in the present invention is an identification code that presents a kind of promotional item acquisition authority which is given to a user in return for provision of personal information by the user, and it is generated based on personal information provided by the user.

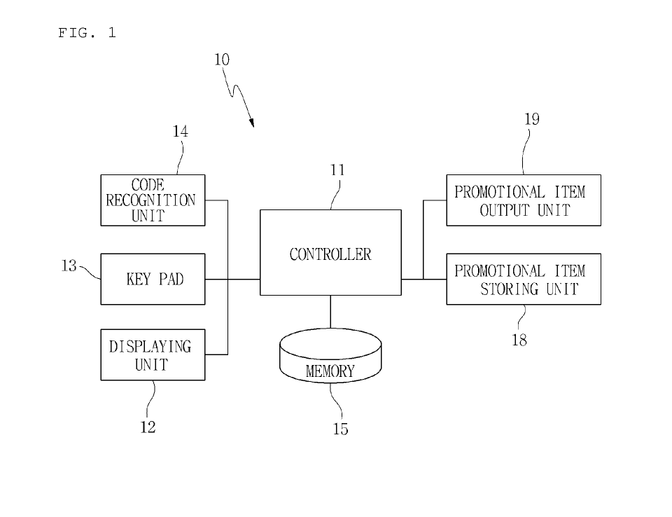

First, with reference to an embodiment according to the present invention illustrated in FIG. 1, the basic configuration of the present invention is described. As illustrated, an automated promotional item dispenser 10 of the present invention includes a controller 11, a displaying unit 12, a key pad 13, an access code recognition unit 14, a memory 15, a promotional item storing unit 18, and a promotional item output unit 19.

The displaying unit 12 is a display means, including a liquid crystal display (LCD), a light emitting diode (LED) lamp, and/or the like, for example, and serves a function of informing the usage of the apparatus of the user, outputting an error message, or the like.

The key pad 13 is an input means, including key buttons that can be operated by the user, and enables the user to perform an input action such as inputting a necessary content according to an information message displayed on the displaying unit 12, selecting a desired promotional item, or the like.

The access code recognition unit 14 is a means for recognizing an access code provided by a user. The access code may be an identification code which is physically imprinted on the base material of a plastic resin material, for example, and in this case, the access code recognition unit 14 may be an apparatus that can recognize the physical imprinted state. According to another method, the access code may be information stored on a magnetic strip or may be implemented by a digital identification code stored in an electronic card using an RFID (Radio-Frequency IDentification) technology or an electronic chip installed in a portable terminal, and the access code recognition unit 14 in this case can be configured as a reader that can read the electronic information.

The memory 15 stores reference information to be compared with a recognized access code. The reference information may include information for distinguishing whether each of the recognized access codes has a qualification for being provided a selected promotional item. For this, access code information that acknowledges whether the access code is a proper access code or not and limiting condition information of a promotional item that can be provided with respect to each of the access codes may be stored in the memory 15. In addition, as time elapses, promotional item provision status information indicating, for example, the kinds and quantities of promotional items is provided with respect to each of the access codes and when and where they are provided.

The promotional item storing unit 18 is a means that loads one or more promotional items of one or more kinds, and the promotional item output unit 19 is a means that outputs a promotional item outside the apparatus from the promotional item storing unit 18.

The controller 11 determines whether to provide a promotional item selected by a user by comparing an access code manually input from the key pad 13 or recognized by the access code recognition unit 14 with the reference information stored on the memory 15, and controls each of the units based on the determination.

According to the configuration as described above, after inputting an access code to the automated promotional item dispenser 10 that can be installed in a specific shop or in a subway station, for example, the user selects a desired promotional item and is provided with the selected promotional item.

Herein, the “access code” that the user provides is provided from a promotional item provider in advance. After providing his/her personal information on the condition that a promotional item will be provided from the promotional item provider in return, the user can receive the access code in which the personal information is included in a coded manner.

The process for receiving the access code may be performed in an off-line shop, may be performed online based on a communication network such as the Internet or the like, or may be provided in the automated promotional dispenser itself.

In the case that the process for receiving the access code is performed in an off-line shop, the promotional item provider may provide a user with an access code as a figure-character mixed code printed on a paper ticket or provide an access code in a form of an electronic card or an electronic chip in which the access code is stored in a form of digital information.

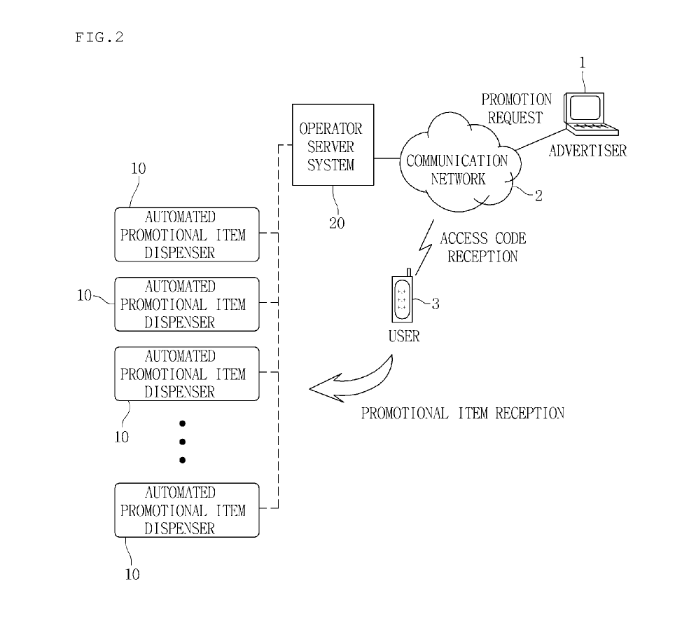

The provision of the access code from the promotional item provider to the user may be performed online, and for this, the promotional item provider may construct an Internet website through a system like an example illustrated in FIG. 2 and operate a service for providing access codes for users who provide personal information in order to acquire the promotional item.

In the example described in FIG. 2, the promotional item provider may build an operator server system 20. The operator server system 20 may provide a website which is configured in an accessible manner by a user equipment 3 through a wired/wireless communication network 2 that can perform a bidirectional data communication. The advertiser who desires to obtain an advertisement or public relations effect through the promotional item can also access the website through an advertiser terminal 1. The operator server system 20 can be configured to respectively register advertisers and users as members, receive requests of promotional items from advertiser members, acquire personal information from user members, and provide the user members with an access code which is an authority for acquiring promotional items in return.

The website system that registers advertisers and users as members is well known in the Internet website technological field, and a system that enables the advertisers to select desired promotional items out of a variety kind of promotional items, print desired advertisement texts on the selected promotional items, and receive commissions for this is also well known, and it is also well known that requesting certain information from a user and enabling the user to download digital information or transmitting other tangible materials in return if the information is input, so in the present disclosure, the detailed configurations for implementing the techniques is omitted.

It is desirable that the personal information provided for receiving the access code according to the present invention is an address for communication including at least one of an email and a portable terminal access number of a user. The address for communication may be provided to an advertiser member as information relating to the user to which the promotional item is provided together with the status of providing the promotional items, afterwards, and the advertiser member may legitimately acquire the address of the user who is provided with the promotional item that they themselves requested, and utilize it for marketing.

In addition, the user may provide additional information including at least one of a name, an address, a resident registration number, a hobby, a job, owned property, and a human relationship of the user as personal information provided for acquiring the access code. As the personal information provided by the user increases, it is desirable that an “updated” access code that enables the user to be provided with a promotional item in a larger number, a wider variety, and a higher quality is provided. In this manner, according to the desired embodiment of the present invention, the access code is automatically provided depending on the quantity and the quality of the personal information of the user in a graded manner, and the graded access code means providing the user with promotional items in a graded manner.

Further, the user may provide biometric information derived from at least one of an iris, a fingerprint, a face shape, and a voice of the user as personal information. The biometric information may be used as unique identification information for preventing an access code from being provided in an overlapped manner.

If the user equipment 3 provides the personal information of the user, the operator server system 20 notifies a limiting condition such as a kind and a quantity of the promotional item that can be provided, an expiration date when the promotional item can be provided, a region where the promotional item can be provided, and/or the like, depending on the grade of the personal information, and also generates an access code including at least a part of the limiting condition and/or the personal information of the user, thereby providing the generated access code to the user equipment 3.

In this case, the user equipment 3 can be a portable terminal such as a cellular phone, for example, and the access code may be used in a state of being stored in the cellular phone. Otherwise, the operator server system 20 generates an access code, manufactures this into a tangible material in a form of an electronic card or an electronic chip, and provides the user with the electronic card or the electronic chip by sending them to an address of an office or a residence of the user.

The operator server system 20 is connected so that data can be transmitted and received to and from a plurality of the automated promotional item dispensers 10 in real time through a communication network, and the operator server system 20 can manage the plurality of the automated promotional item dispensers 10 in real time. However, according to the preferred embodiment of the present invention, the automated promotional item dispenser 10 can be operated when it is not connected to the operator server system 20 via a direct network, and the update of the data or the operation of filling the promotional item can be performed by a separate manager.

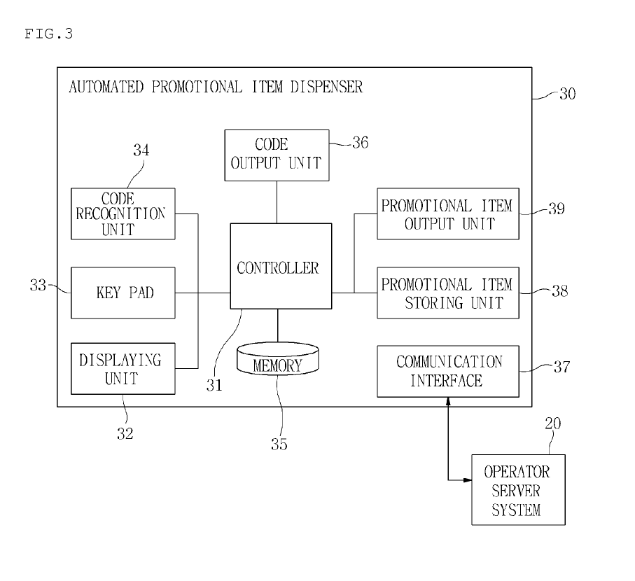

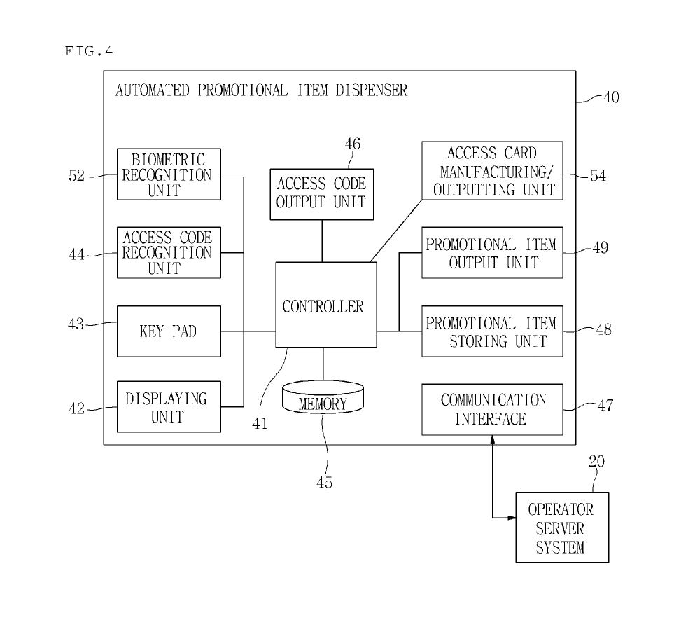

Meanwhile, as shown in the examples illustrated in FIGS. 3 and 4, the promotional item provider can provide access codes to users through automated promotional item dispensers 30 and 40. In the examples like this, if the users provide personal information through various input means installed in the automated promotional item dispensers 30 and 40, a controller in the automated promotional item dispensers can generate access codes according to an internally stored program. The generated access codes can be provided to the users by displaying them on a display screen to be presented to the users, transmitting them to the portable terminals of the users, or manufacturing and printing access cards in a form of an electronic card.

The embodiment of the present invention illustrated in FIG. 3 includes basic configurations as shown in the embodiment illustrated in FIG. 1, and, in addition, is the automated promotional item dispenser 30 that is connected to the operator server system 20 through a communication network and has a function of autonomously generating an access code and printing the generated access code.

The automated promotional item dispenser 30 includes a controller 31, a displaying unit 32, a key pad 33, an access code recognition unit 34, a memory 35, a promotional item storing unit 38, and a promotional item output unit 39, and these perform the functions similar to the corresponding components described with reference to FIG. 1. In addition to this, the automated promotional item dispenser 30 further includes an access code output unit 36 together with a communication interface 37 that can be connected to an external apparatus and the communication network.

In FIG. 3, the automated promotional item dispenser 30 is illustrated by way of example as being connected to the operator server system 20, but it is obvious that it can be configured that the automated promotional item dispenser 30 can be sufficiently operated in a non-connected state.

The embodiment of the present invention illustrated in FIG. 4 includes basic configurations as shown in the embodiment illustrated in FIG. 1, and, in addition, is the automated promotional item dispenser 30 that is connected to the operator server system 20 through a communication network and has a function of autonomously recognizing biometric information of the user, generating an access code based on this, outputting the generated access code, and also manufacturing and outputting an access card in a form of a typical electronic card.

The automated promotional item dispenser 40 includes a controller 41, a displaying unit 42, a key pad 43, an access code recognition unit 44, a memory 45, a promotional item storing unit 48 and a promotional item output unit 49, which perform the functions similar to the corresponding components described with reference to FIG. 1. In addition to this, the automated promotional item dispenser 40 further includes an access code output unit 46 together with a communication interface 47 that can be connected to an external apparatus and the communication network like the embodiment illustrated in FIG. 3. In addition to this, the automated promotional item dispenser 40 includes a biometric recognition unit 52 that can recognize biometric information such as fingerprint or iris information of the user and an access card manufacturing/outputting unit 54 that can manufacture and output an access card in a form of an electronic card.

In FIG. 4, the automated promotional item dispenser 40 is illustrated by way of example as being connected to the operator server system 20, but it is obvious that it can be configured that the automated promotional item dispenser 40 can be sufficiently operated in a non-connected state.

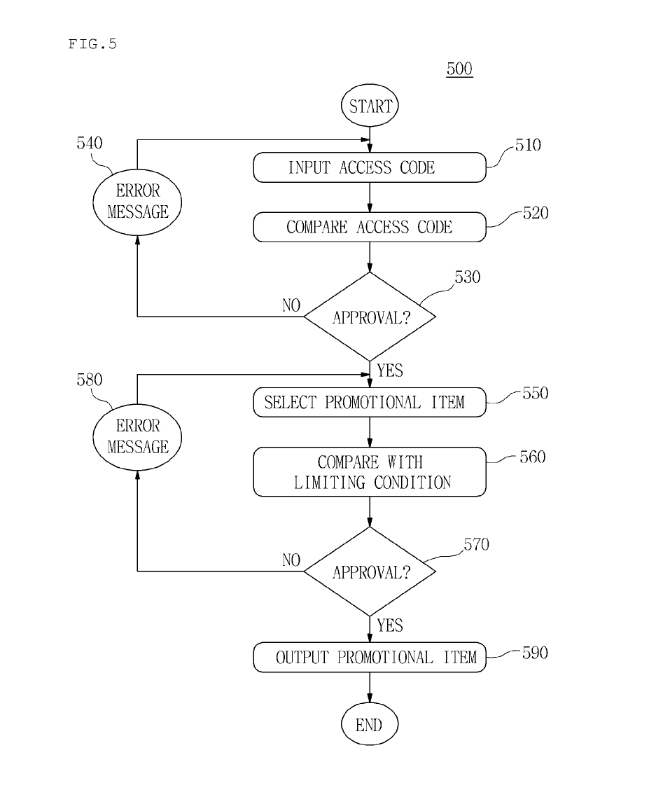

FIGS. 5 to 7 are flowcharts illustrating processes of providing promotional items from automated promotional item dispensers according to the embodiments of the present invention, respectively.

FIG. 5 shows a basic promotional item providing process. In the illustrated example, when a promotional item providing process 500 is started, a step 510 of inputting an access code by a user proceeds. In the way of inputting an access code by a user, depending on whether the access code is in a form of an electronic card, is in a state of digital information stored in an electronic chip of a portable terminal, or is a code such as a series of figures and characters in a mixed manner printed on a paper ticket, the access code is recognized by an access code recognition unit in the form of an electronic card reader or a portable terminal electronic chip reader. Otherwise, the user may directly type and input a figure-character code printed on a paper ticket by using an input apparatus such as a key pad.

Thereafter, after the input or recognized access code is compared with stored basic information (520), it is determined whether or not the access code is an access code having proper authority (530). When it is not approved (“No” in 530), an error message is displayed to the user (540), and the user cannot proceed to the next step until he/she enters a proper access code. When it is approved (“Yes” in 530), the user can select a desired promotional item (550). In addition, the access code of the user may be again checked whether the selected promotional item can be provided (560). A limiting condition for determining the provision of the promotional item is determined when the user receives an access code, and a kind, a quantity, the number of times for provision, an expiration date for provision, a region, or the like may be checked (570). When it is approved that the selection is proper (“Yes” in 570), the selected promotional item is output to be provided to the user (590). When the selection is not proper (“No” in 570), an error message is displayed to the user (580), and the user cannot proceed to the next step until he/she selects a proper promotional item.

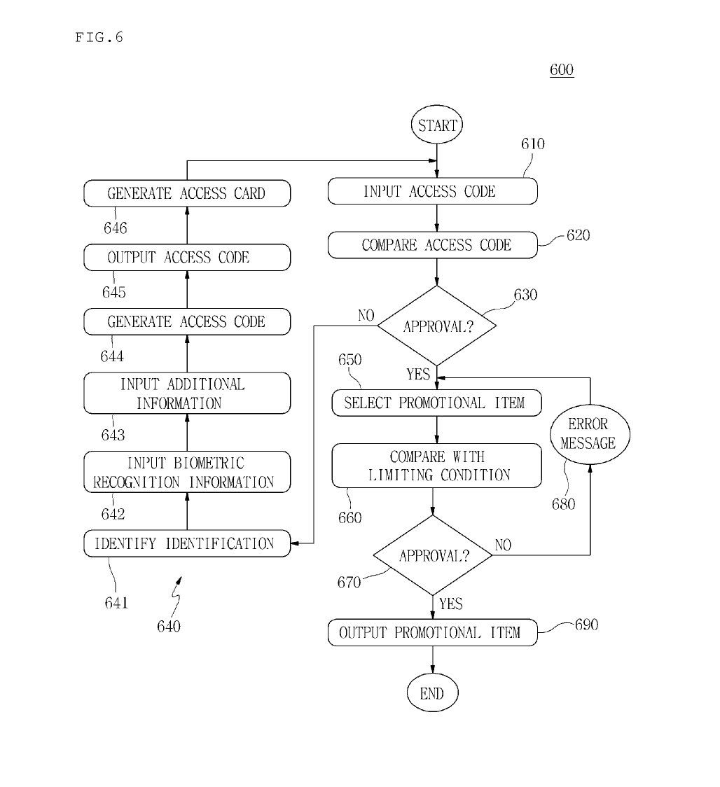

FIG. 6 illustrates an example in which a step in which the user can receive an access code is configured in addition to the process illustrated in FIG. 5 which is the basic promotional item providing process according to the present invention. When the promotional item providing step (600) is started in the illustrated example, a step 610 of inputting an access code by a user proceeds. When it is confirmed that the user does not have a proper access code (520 and “No” in 530), not a simple error message, but a process 640 of newly issuing an access code is presented to a user.

The process 640 of newly issuing an access code can be started while a step 641 of identifying an identity of the user proceeds. Here, the user may be requested to input his/her own cellular phone number or e-mail address. For example, the user may complete identification by inputting an identification number transmitted to the cellular phone or the e-mail. Afterwards, biometric recognition information such as a fingerprint, an iris, a face shape, or the like may be selectively input (642). In addition, additional information such as a name, a home address, or a resident registration number of the user may be selectively input, if necessary (644). The input of the personal information is completed in this manner, a new access code including the limiting condition with respect to the promotional item that can be acquired based on the input personal information is generated (644), and the generated access code is output by being displayed on the screen to the user or by being transmitted to the cellular terminal of the user (645), or provided by being generated in a form of an electronic card (646).

Afterwards, the user uses the newly generated access code and goes through the acceptance procedures (610, 620, 630), and if the access code is accepted (“Yes” in 630), the user selects a desired promotional item and receives the promotional item after the selection is compared and checked with the limiting condition (650 to 690).

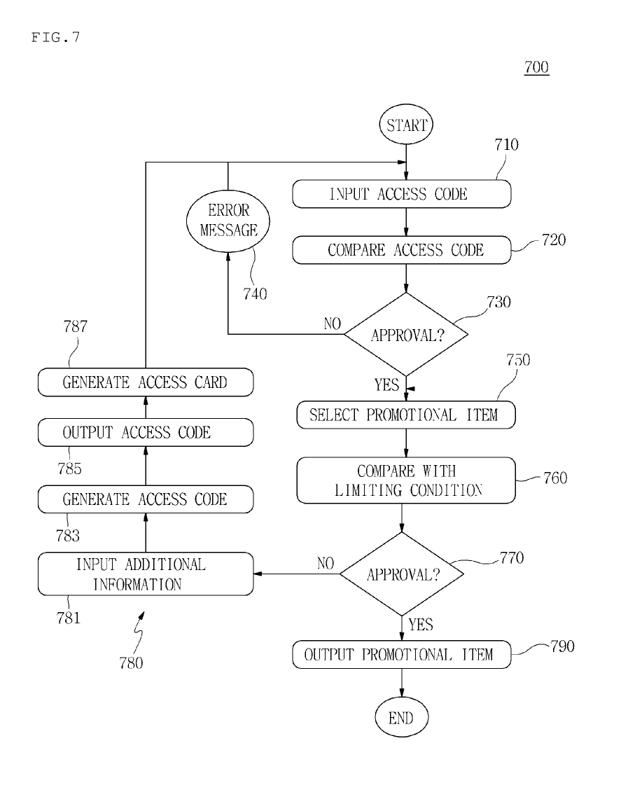

FIG. 7 illustrates an example in which the user discards an existing access code in order to receive a desired promotional item, additionally provides new personal information, and receives a new access code with a new limiting condition (780) in addition to a process illustrated in FIG. 5 which is the basic promotional item providing process according to the present invention.

In the illustrated example, when the promotional item providing process 700 is started, a step 710 of inputting an access code by the user proceeds, and checking 720 and determination 730 are performed. When the access coded is accepted as a proper access code (“Yes” in 730), the user may select a desired promotional item (750). However, when the access code of the user is checked (760) as to whether the user can receive a selected promotional item, if the selection is not proper (“No” in 770), a simple error message is not displayed to the user but an opportunity to receive a new access code by further inputting an additional information may be given to the user (780).

A process 780 of newly receiving an access code in order to expand the limiting condition of the promotional item may selectively request additional information such as a name, a home address, a resident registration number, or the like of the user from the user, if necessary (781). When the input of the additional information is completed in this manner, an access code is generated (783), the generated access code is output to the user by being displayed on the screen or being transmitted to the portable terminal of the user (7855) or the generated access code is generated and provided in a form of an electronic card (787).

Afterwards, the user uses a newly issued access code to go through the acceptance processes (710-730), and when the access code is accepted (“Yes” in 730), the user selects a desired promotional item and receives the promotional item after the selection is compared and checked with the limiting condition (750-790).

The present invention is described with the specific embodiments above, but various and modified construction methods are possible by those skilled in the art by referring to and combining various features described in the present disclosure. Therefore, it should be noted that the scope of the present invention is not limited to the described embodiments but construed by the accompanying claims.

1. An automated promotional item dispenser storing one or more promotional items of at least one kind and providing a kind and a quantity of the promotional item selected by a user from among the stored promotional items according to a request of the user, the automated promotional item dispenser comprising:
a display means that performs a display to the user and an input means that the user can operate;
an access code recognition unit for recognizing an access code which is an identification code provided by the user and indicating an acquisition authority of the promotional item;
a memory storing reference information that is information compared with the recognized access code and that can distinguish whether or not the recognized access code has an authorization to receive a promotional item selected by the user;
a promotional item storing unit and a promotional item output unit for storing promotional items and providing the promotional items to the user; and
a controller that compares the reference information and the access code, determines whether to provide the promotional item selected by the user, and controls each of the units depending on the determination,
wherein the access code, which is provided by the user, is provided in advance by the promotional item provider after the user provides at least one item of his/her own personal information on the condition that the promotional item can be provided in return, and which includes the provided personal information in a coded manner, and
the promotional item acquisition authority of the access code is provided depending on a kind and a quantity of the provided personal information in a graded manner.

2. The automated promotional item dispenser as claimed in claim 1, wherein the provision of the access code from the promotional item provider to the user is performed between a user terminal and an operator server system of a promotional item provider that can be connected through a communication network that can perform a bidirectional data communication with a user terminal providing personal information of the user and the operator server system generating the access code and providing the access code to the user terminal through the communication network.

3. The automated promotional item dispenser as claimed in claim 1, wherein the provision of the access code from the promotional item provider to the user is performed by the user providing the user's personal information by the input means, and the controller generating the access code to display the access code to the user, to transmit the access code to a portable terminal of the user, or to manufacture and output an access card in a form of an electronic card.

4. The automated promotional item dispenser as claimed in claim 1, wherein the access code includes at least one item of information physically imprinted on an electronic card provided to the user, magnetically readable information, and information readable by a near field communication means.

5. The automated promotional item dispenser as claimed in claim 1, wherein the access code is provided in a form of a code transmitted to a portable terminal of the user.

6. The automated promotional item dispenser as claimed in claim 1, wherein the personal information provided for receiving the access code comprises an address for a communication including at least one of an e-mail and a portable terminal connection number of the user.

7. The automated promotional item dispenser as claimed in claim 6, wherein the personal information provided for receiving the access code further comprises additional information including at least one of a name, a home address, a residence registration number, a hobby, a job, owned property, and a human relationship of the user.

8. The automated promotional item dispenser as claimed in claim 6, wherein the personal information provided for receiving the access code further comprises biometric information derived from at least one of an iris, a fingerprint, a face shape, and a voice of the user.

9. The automated promotional item dispenser as claimed in claim 1, wherein the access code further comprises a limiting condition including at least one of a kind, a quantity, a providable date, and a providable region in a coded manner depending on the kind of the personal information provided by the user.

10. The automated promotional item dispenser as claimed in claim 1 further comprising a communication interface that enables wired/wireless data communication respectively, wherein a plurality of the automated promotional item dispensers are connected to an operator server system of the promotional item provider through the respective communication interfaces so that the user relating to the promotional item provision and the data relating to the promotional item are configured to be mutually updated.

11. An automated promotional item providing method of storing one or more promotional items of at least one kind and providing a kind and a quantity selected by a user from among the stored promotional items according to a request of the user, the automated promotional item providing method comprising:
a step of providing, by the promotional item provider, an access code to the user which is an identification code including the provided information in a coded manner, after after providing at least one item of his/her own personal information on the condition that the promotional item can be provided in return, and to which a promotional item acquisition authority is given depending on a kind and a quantity of the provided personal information;
a step of recognizing an access code provided by the user which is an identification code indicating an acquisition authority of a promotional item;
a step of comparing the recognized access code with reference information which is stored in advance and is information that can distinguish whether or not the recognized access code has an authorization to receive a promotional item selected by the user;
a step of determining whether to provide a promotional item selected by the user based on the comparison result; and
a step of outputting an error message when it is determined that the provision is not permitted, or outputting the determined promotional item when it is determined that the provision is permitted.

12. The automated promotional item providing method as claimed in claim 11, wherein the step of providing, by the promotional item provider, an access code to the user is performed between a user terminal and an operator server system of a promotional item provider that can be connected through a communication network that can perform a bidirectional data communication with a user terminal providing personal information of the user and the operator server system generating the access code and providing the access code to the user terminal through the communication network.

13. The automated promotional item providing method as claimed in claim 11, wherein the access code comprises at least one item of information physically imprinted on an electronic card provided to the user, magnetically readable information, and information readable by a near field communication means.

14. The automated promotional item providing method as claimed in claim 11, wherein the access code is provided in a form of a code transmitted to a portable terminal of the user.

15. The automated promotional item providing method as claimed in claim 11, wherein the personal information provided for receiving the access code comprises an address for communication including at least one of an e-mail and a portable terminal connection number of the user.

16. The automated promotional item providing method as claimed in claim 15, wherein the personal information provided for receiving the access code further comprises additional information including at least one of a name, a home address, a residence registration number, a hobby, a job, owned property, and a human relationship of the user.

17. The automated promotional item providing method as claimed in claim 15, wherein the personal information provided for receiving the access code further comprises biometric information derived from at least one of an iris, a fingerprint, a face shape, and a voice of the user.

18. The automated promotional item providing method as claimed in claim 11, wherein the access code further comprises a limiting condition including at least one of a kind, a quantity, a providable date, and a providable region in a coded manner depending on the kind of the personal information provided by the user.

19. The automated promotional item providing method as claimed in claim 11, further comprising:
a step of mutually updating the user relating to the promotional item provision and the data relating to the promotional item by connecting a plurality of the automated promotional item dispensers to an operator server system of the promotional item provider through the respective communication interfaces.
